(19) United States
(12) Patent Application Publication
(10) Pub. No.: US 2025/0376408 A1
(43) Pub. Date: Dec. 11, 2025

(54) Method and preform for producing a hollow core fiber and method for producing a preform for a hollow core fiber

(71) Applicant: Heraeus Quarzglas GmbH & Co. KG, Hanau (DE)

(72) Inventors: Jan VYDRA, Bitterfeld-Wolfen (DE); Kay SCHUSTER, Bitterfeld-Wolfen (DE); Manuel ROSENBERGER, Kleinostheim (DE)

(21) Appl. No.: 19/225,490

(22) Filed: Jun. 2, 2025

(30) Foreign Application Priority Data
Jun. 6, 2024 (EP) 24180448.3

(51) Int. Cl. C03B 37/025; C03B 37/012

(52) U.S. Cl. CPC C03B 37/0256; C03B 37/0124; C03B 2203/16

(57) ABSTRACT

A preform for an anti-resonant hollow core fiber which comprises a hollow core extending along a fiber longitudinal axis and a jacket surrounding the hollow core and traversed by hollow channels, wherein the preform has an outer diameter OD and a length L, wherein OD is at least 25 mm, and the ratio L/OD is greater than 71.5. A method for producing a preform for an anti-resonant hollow core fiber as described above, comprising thermally drawing a cylindrical preliminary product having a length of less than 3000 mm.

### CROSS-REFERENCE TO RELATED APPLICATIONS

This application claims priority pursuant to 35 U.S.C. 119 (a) to European Patent Application No. 24180448.3, filed Jun. 6, 2024, which application is incorporated herein by reference in its entirety.

### FIELD OF THE INVENTION

The invention relates to the field of optical fiber technology and, in particular, to the area of antiresonant hollow-core fibers (AR-HCF for short). The hollow core region is surrounded by a microstructured jacket in which so-called “antiresonant elements” (“AREs” for short) are arranged. These usually form hollow channels that are separated from each other by glass membranes. The glass membranes arranged around the hollow core can reflect the incoming light and thus guide it through the fiber core. Hollow core fibers allow light to be guided within a “hollow” core that is either evacuated or filled with a gas (for example, air).

This fiber technology promises low optical attenuation, a very broad transmission spectrum (even in the UV or IR wavelength ranges) and low latency time during data transmission. In addition, these fibers are suitable for spectroscopic applications and for the transmission of short laser pulses for high-power beam guidance, for example for material processing, modal filtering, nonlinear optics, in particular for supercontinuum generation, from the ultraviolet to the infrared wavelength range.

In particular, the invention relates to a preform for an antiresonant hollow core fiber comprising a hollow core extending along a fiber longitudinal axis and a microstructured jacket region surrounding the hollow core.

Furthermore, the invention relates to a method for producing a preform for an antiresonant hollow core fiber comprising a hollow core extending along a fiber longitudinal axis and a microstructured jacket region surrounding the hollow core, and to a method for producing such an antiresonant hollow core fiber by drawing from a preform.

### BACKGROUND

It is known to draw antiresonant hollow-core fibers from preforms that have a hollow core surrounded by a jacket in which at least some of the AREs are arranged as a cross-sectional structure traversed by hollow channels.

The preform is produced, for example, by collapsing and/or elongating a cylindrical preliminary product, which can then be covered with additional jacket material. The cylindrical preliminary product is, for example, an ensemble consisting of a jacket tube and a plurality of cylindrical starting components, or it is a solid hollow cylinder comprising the hollow core and the jacket traversed by hollow channels, and which is also referred to below as the “core preform” (English: cane). The core preform can be obtained by collapsing and/or elongating such cylindrical starting components in a jacket tube, wherein additional jacket material can also be collapsed in this method step by overlaying with an overlay cylinder. Starting components of the preliminary product, which form the cross-sectional structure traversed by hollow channels in the preform and the AREs in the finished hollow core fiber, are also referred to below as “ARE preforms”.

In particular, it is known to draw antiresonant hollow core fibers from preforms comprising a hollow core region and a jacket region traversed by hollow channels extending between a first preform end and a second preform end. The preform is fed to a heating device starting with the first end, is softened therein in part, and the hollow core fiber is continuously drawn off from the softened part while a remaining preform length is shortened. In order to prevent the hollow channels of the cross-sectional structure from collapsing during the fiber drawing process, they are usually subjected to overpressure. In order to provide a method for producing an antiresonant hollow core fiber by drawing from a preform, which ensures that the hollow channels of the cross-sectional structure can be reliably and reproducibly subjected to overpressure during the fiber drawing process, it is proposed that at least one means for applying pressure is arranged at the second preform end, and that the thermal drawing is terminated as soon as the means for applying pressure and/or the second preform end has reached a predetermined limit temperature and/or the remaining preform length has fallen below a predetermined minimum length.

A preliminary product for a hollow core fiber with the so-called NANF design (Nested Antiresonant Nodeless Hollow Core Fibers) contains a plurality of ARE preforms, in the simplest case each consisting of an outer tube (hereinafter also referred to as “primary tube”) and an inner tube (hereinafter also referred to as “secondary tube”), which is arranged on the inside of the primary tube.

In a DNANF design (Double Nested Antiresonant Nodeless Hollow Core Fibers), an additional inner tube, which can also be referred to as a “tertiary tube,” is arranged in the secondary tube. The secondary and tertiary tubes form additional hollow channels in the hollow core fiber, which contribute to reducing optical fiber attenuation by causing multiple radial reflections and avoiding transitions or nodes that cause resonances.

In the so-called “ALIF” (Antiresonant Leakage Inhibited Fibers) design, a pair of secondary tubes are inserted on the inside of the primary tube, which are spaced apart and attached at azimuthal locations around the circumference of the primary tube, both offset from the peripheral contact point of the primary tube on the jacket tube. There is therefore an open gap between each pair of secondary tubes in radial direction.

Polarization-maintaining hollow core fibers contain AREs in which the arrangement of the primary tubes and secondary tubes or the hollow channels created from them has an asymmetry that leads to a preferential conduction of light of one polarization.

During the fiber drawing process, the preform is “elongated” or “thermally drawn” to form a hollow core fiber. The “draw ratio” or “extraction ratio” is the ratio between the outer diameter or cross-sectional area of the preform and the outer diameter or cross-sectional area of the hollow core fiber. The preform is fed, starting with one end and at a feed rate, to a heating device in which the glass is softened in part, and from the softened glass volume, the hollow core fiber is drawn continuously and at a drawing rate in the drawing direction, forming a deformation zone, which is also referred to as a “drawing bulb.” The drawing direction can have any orientation in space; usually it is vertical.

In order to achieve the most efficient fiber drawing process possible, the aim is to achieve the greatest possible fiber length from a single preform. This is achieved by using large-volume preforms, so that a larger starting volume of glass is available for conversion into fibers. An increase in volume can be achieved by increasing the preform length and/or the preform diameter.

In an approach known from WO 2024/015191 A1, a thin but very long preform is used. The preform is, for example, in the form of a long filament with an outer diameter in the range of 0.5 to 5 mm and a total length of at least 30 m and can be continuously unwound from a spool during the fiber drawing process. The heating device is two-stage, with two heating zones arranged one behind the other in the drawing direction. In the upper heating zone, the preform is elongated to an intermediate preform, and from this the final hollow core fiber is drawn in the lower heating zone. The preform should be drawn out as completely as possible, with the total extraction ratio being in the range of 2 to 150.

A different design is known from EP 3 766 844 A1. There, an antiresonant hollow core fiber is drawn from a relatively thick-walled preform with an outer diameter in the range of 30 to 90 mm. In the fiber drawing process, the preform, in the case of a vertically oriented longitudinal axis, is fed from above to a temperature-controlled heating zone and softened therein in zones, starting at the lower end. Gas is supplied to the core region (hollow core) so that an internal overpressure is created in the hollow channels in the core area.

### Technical Problem

In order to comply with resonance or antiresonance conditions, even small dimensional deviations in the order of magnitude of the working wavelength of the light to be guided are not tolerable. Therefore, the dimensionally precise production of the complex cross-sectional structures of the hollow core fiber represents a major challenge. Dimensional deviations can occur due to unintentional deformations during the fiber drawing process and they can already be inherent in the fiber preform, in particular due to deviations in the wall thickness of the walls of ARE preforms and in their azimuthal position, which can be caused for example by bending during preform production.

The cross-sectional structure of the hollow core fiber can differ from that of the preform. In order to adjust the diameters of the hollow channels and the wall thickness of the glass membranes between the hollow channels precisely, it is necessary to apply overpressure to the hollow channels of the preform or the ARE preforms during the drawing of the hollow core fiber. The pressure application counteracts the surface tension of the softened material, which would otherwise lead to the collapse of the hollow channels and the destruction of the intended cross-sectional structure.

The pressure application is often differential in the sense that different pressures are applied to the hollow core and to different hollow channels. Therefore, it is often necessary to connect a complex pressure system to the preform, which requires individual seals. Sealing parts made of plastics material can be used to seal the pressure system, but many of them degrade at high temperatures. Although polyimides are more temperature-stable, they are too hard and therefore poorly suited to sealing. Therefore, during the fiber drawing process, the temperature at the upper end of the preform, where the pressure connection is made, should be maintained at a temperature that prevents degradation of the pressure system. This preform end is also referred to as the “connection end” below.

An object of the invention is therefore to provide a method for producing an antiresonant hollow core fiber by drawing from a preform, which ensures that the hollow channels of the cross-sectional structure are reliably and reproducibly subjected to an overpressure during the fiber drawing process.

Furthermore, the invention is based on the object of providing a preform which is characterized by high dimensional stability and accuracy of its cross-sectional structure and which is particularly suitable for carrying out the fiber drawing process.

Furthermore, it is an object of the invention to indicate a method which enables the most dimensionally precise possible production of such a preform.

### SUMMARY OF THE INVENTION

With regard to the preform for producing the antiresonant hollow-core fiber, this object is achieved by a method having the features of claim 1. Advantageous embodiments of the preform are indicated in the dependent claims.

A hollow core fiber is produced from the preform by a fiber drawing method as indicated in claim 10. This method achieves the above-mentioned technical object relating to the production of the hollow core fiber.

In this production method, structural aspects of the preform and method features of the fiber drawing method interact, so that these aspects and features are considered and explained together below.

During the fiber drawing method, an excessive temperature increase at the connection end of the preform (i.e., at the connection point for the application of pressure to the hollow channels of the cross-sectional structure) is to be prevented.

The preform is heated in the heating zone from the outside to the inside. A radial temperature gradient is created within the preform from the outside (hot) to the inside (cold). Among other things, the temperature gradient within the preform depends on the outer diameter of the preform and its dwell time in the heating zone, which in turn is determined by the relative feed rate of the preform into the heating zone and its length.

The fiber drawing process requires that the entire cross-sectional structure of the preform has a sufficiently low viscosity, i.e. not only the outer jacket region, but also the inner jacket region of the preform, which is traversed by hollow channels. This means that a minimum temperature Tₘᵢₙ must be achieved in the inner jacket region of the preform, which temperature is high enough to ensure sufficiently viscous flow behavior for the given dwell time in the heating zone. Due to the inwardly decreasing temperature profile, the temperature in the outer jacket region is always higher than Tₘᵢₙ and is hereinafter referred to as Tₘᵢₙ₊. For a given temperature gradient, the difference between Tₘᵢₙ₊ and Tₘᵢₙ is a function of the thickness of the preform wall and thus of the preform outer diameter. The larger the preform outer diameter, the greater the temperature difference and the higher Tₘᵢₙ₊.

Therefore, for efficiency reasons, it can be expedient to equip the preform with the largest possible outer diameter. However, in the case of very thick-walled preforms with a large outer diameter there is a risk that Tₘᵢₙ₊ must be so high that a temperature above a specified limit temperature of for example 250° C., preferably 200° C., is permanently established in the region of the connection point for applying pressure.

To counteract this, the invention proposes on the one hand that the preform outer diameter OD is at least 25 mm, with the additional proviso that the ratio L/OD is greater than 71.5.

The preform outer diameter OD is preferably not larger than 50 mm, preferably not larger than 45 mm. Particularly preferably, the outer diameter OD is less than 30 mm.

The preforms therefore have a small to medium-sized outer diameter, which counteracts the formation of a large radial temperature gradient during thermal drawing.

However, at an outer diameter of less than 25 mm the preform no longer meets the efficiency criterion.

However, preforms with outer diameters of more than 25 mm still have a comparatively large cross-sectional area through which heat is transported from the heating zone to the connection end. This in turn means that the connection end continues to heat up during the fiber drawing process and eventually reaches such a high temperature that the pressure and sealing parts located there can be destroyed.

To counteract this, the invention proposes, on the other hand, that the ratio L/OD is greater than 71.5. Preferably, the ratio D/L is less than 500, and preferably has a value in the range between 80 and 200, and particularly preferably in the range between 90 and 150. The ratio L/OD determines a minimum length of the preform depending on its outer diameter. For example, with a minimum outer diameter of 25 mm, the minimum length of the preform is 1.788 m. This is a comparatively large preform length. Preferably, the preform has a length L of at least 3 m, preferably at least 4 m.

Certain thermal management measures can be carried out more efficiently with long preforms (at the same weight), such as thermal management measures to improve heat dissipation by scattering, for example by roughening part of the outer surface of the preform.

In addition, the long preform length makes it easier to keep the connection end of the preform or the means for applying pressure sufficiently far away from the heating zone by terminating the fiber drawing process before the temperature at the connection end and/or the means for applying pressure becomes too high, and in particular exceeds the limit of 200° C.

In the method according to the invention, the preform is therefore not completely elongated to form a hollow core fiber, but the fiber drawing process is terminated at the latest when/or the remaining preform length has fallen below a predetermined minimum length and/or when the temperature at the connection end exceeds the temperature limit value, wherein the occurrence of this condition can be determined either by measuring the temperature, empirically, or by calculation or model-based prediction.

The transported heat power is inversely proportional to the length L and directly proportional to the material-covered cross-sectional area CSA of the preform.

$${P}_{Q} = lambda ⋆ A / L ⋆ ( T 1 - T 2 ) \qquad ( 1 )$$

PQ=transported heat power
Lambda=thermal conductivity coefficient
CSA=material-covered cross-sectional area of the preform
L=length of the preform
T1=temperature in the heating zone
T2=temperature at the connection end

The length L represents, for example, the preform length section between the heating zone and the connection end or the “remaining length” of the preform. It can therefore be deduced from equation (1) that thicker preforms must have a larger remaining length, for the same coupled-in power, in order not to exceed a critical temperature T2 at the connection end.

With the thermal conductivity coefficient for quartz glass between 1.38 W/mK (at 20° C.) and 15 W/mK (at 2000° C.), it follows that the ratio CSA/L should be less than 0.00095 (in m). For this estimation, an inner diameter can be assumed for the calculation of CSA that does not take into account the inner jacket region on the inside of the preform, which is permeated with hollow channels, so that the contribution of the ARE preforms to the material-covered cross-sectional area of the preform is neglected.

The lost preform length (preform remaining length LR) is typically less than 500 mm, but is preferably at least 300 mm, particularly preferably at least 400 mm. In view of the large original overall length and the only medium-sized preform outer diameter, the material loss is acceptable. With an initial preform mass of preferably at least 3 kg, the remaining length is at most a fraction.

Alternatively, the connection point for applying pressure could be provided at the upper end of a sufficiently long holding cylinder (dummy cylinder) instead of the preform, which cylinder is connected in gas-tight fashion to the upper end of the preform. However, such a holding cylinder would have to reliably ensure the fluidic connection to all hollow channels of the cross-sectional structure, which can be very close and tightly adjacent, and its production would be similar in complexity to that of the preform itself. Therefore, this method alternative is not preferred over the long preform and the acceptance of material loss.

The preform used in the fiber drawing process therefore has a large length but only a medium-sized outer diameter. This is reflected in a large ratio of preform length L to outer diameter OD, which is greater than 71.5.

In this context, it has proven successful for the preform to have a volume V (in mm³) and an outer surface area A (in mm²) and for the ratio V/A to be less than 12 (in mm).

The ratio V/A can be regarded as a measure of surface-influenced heat conduction. The smaller this ratio, the (relatively) larger the surface over which heat dissipation can potentially occur. With the same volume, certain heat management measures can be carried out more efficiently with long preforms, for example to improve heat dissipation through scattering, such as roughening part of the outer surface of the preform. With this estimate as well, the volume can be approximately limited to the solid glass volume; that is, the contribution of the ARE preforms to the glass volume can be neglected.

During the fiber drawing process, if the feed rate is too high, radial temperature gradients can occur in the preform, which can have the result that the cross-sectional structures therein, distributed at different radial positions, are drawn differently. A feed rate that is too low can lead to undesired deformations of the cross-sectional structure. It has proven to be a suitable compromise for the feed rate to be set so as to result in a throughput of at least 0.8 g/min, preferably a throughput in the range of 0.8 g/min to 150 g/min, and particularly preferably a throughput in the range of 3.3 g/min to 85 g/min.

In addition, the feed rate is preferably set so that the average dwell time of the preform in the heating zone is less than 25 minutes, preferably in the range of 1.5 to 25 minutes.

In order to reduce absolute geometry errors, a large extraction ratio during the fiber drawing process is desired. On the other hand, a large extraction ratio is associated with correspondingly large forming processes and material movements, which can easily lead to undesired deformations in the delicate cross-sectional structure of the preform.

As a suitable compromise, it has proven to be advantageous if the extraction ratio during the fiber drawing process is set to a value in the range of 100 to 200, preferably to a value in the range of 120 to 180.

With regard to the method for producing a preform for an antiresonant hollow-core fiber, the above-mentioned object is achieved by a method having the features of claim 7. Advantageous procedures are specified in dependent claims 8 to 9.

The preform is produced by drawing a cylindrical preliminary product that has a larger outer diameter but a shorter length than the preform.

The preliminary product is, for example, a core preform (cane) or it is an ensemble comprising a jacket tube and a plurality of ARE preforms surrounded by the jacket tube. During thermal drawing, the preliminary product can be overlaid with additional jacket glass, for example by collapsing an overlay cylinder.

Regardless of whether the preliminary product is available as a core preform or as an ensemble, cylindrical, comparatively delicate ARE preforms are used in its production, which preforms must be aligned and positioned as precisely as possible. These processes are usually carried out with the longitudinal axes of the ARE preforms oriented horizontally, with inherent bending of the preforms. However, even with the longitudinal axes of the ARE preforms oriented vertically, a bend may be impressed on the preforms, which has an adverse effect on the dimensional accuracy of the preliminary product.

Because the preliminary product has a short length of less than 3000 mm, preferably a length of less than 2500 mm, and particularly preferably a length of less than 2000 mm, the absolute bending of the ARE preforms used can be kept as low as possible. In addition, a short length of the ARE preforms used is advantageous, as their rigidity is then greater than that of long ARE preforms. The thermal drawing of the preliminary product to produce the preform takes place in a single drawing step or in a plurality of drawing steps, particularly preferably in two drawing steps. When the preliminary product is thermally drawn in a plurality of drawing steps, the cross-sectional structure of the preliminary product can be transferred to the cross-sectional structure of the preform with greater dimensional accuracy and reproducibility.

In addition, the cylindrical preliminary product advantageously has a comparatively large outer diameter, in the range of 40 mm to 200 mm, preferably an outer diameter of at least 60 mm, and particularly preferably of at least 70 mm. The ARE preforms used can have a comparatively large outer diameter, which also increases their rigidity and thus reduces the risk of bending.

Overall, it is therefore preferable to produce preliminary products that are as large but as short as possible, as these are characterized by comparatively better dimensional accuracy and, in particular, less bending of the ARE preforms. Furthermore, it is advantageous to produce the preform by thermal drawing of preliminary products that are as large but as short as possible, since the short-length preliminary product has greater accuracy in terms of its geometry.

For example, a preform with an outer diameter of 25 mm and a length of over 10 m can be produced from a preliminary product with an outer diameter of 90 mm and a length of 1000 mm.

Since the effort required for preparing the preform and for connecting it for applying pressure is just as time- and equipment-intensive for short preforms as it is for long preforms, it makes economic sense to produce preforms from the preliminary product that are as long as possible. When drawing fibers from a long preform, the number of setup operations can be comparatively reduced and the run-up times in the fiber drawing process can be reduced.

### Definitions

Individual method steps and terms of the above description are further defined below. The definitions are part of the description of the invention. In the event of a substantive inconsistency between one of the following definitions and the rest of the description, the statements made elsewhere in the description take precedence.

For terms and measurement methods that are not specifically defined in the description, the interpretation according to the International Telecommunication Union (ITU) shall apply. If no measurement method is specified for a parameter, the standard measurement method shall be used for that parameter and, in particular, the measurement method laid down in the relevant ISO standard whose publication date is closest to that of the present application. If measurement conditions are not specified, the standard conditions (SATP conditions) for the temperature shall be 298.15 K (25° C., 77° F.) and for the absolute pressure 100 kPa (14.504 psi, 0,986 atm).

### Antiresonant Elements

Antiresonant elements (AREs for short) can be simple or interleaved structural elements of the hollow core fiber. They comprise at least two walls which, viewed from the direction of the hollow core, have a negative curvature (convex) or no curvature (flat, straight). They generally consist of a material that is transparent to the working light, for example glass, in particular doped or non-doped SiO₂, a plastic, in particular a polymer, a composite material or a crystalline material.

### Preform

The preform is the component or component ensemble from which the antiresonant hollow core fiber is drawn using a fiber drawing process. The core-jacket-cross-sectional structure of the hollow core fiber can already be geometrically designed in the preform by the relative arrangement of the ARE preforms to each other or the hollow channels created from them and their angular distribution. However, the size ratios of the hollow channels are often changed during the fiber drawing process.

### Preliminary Product-Ensemble-Core Preform

The preform is obtained by thermally drawing a preform preliminary product once or multiple times. The preform preliminary product (for short: preliminary product) is, for example, a more or less loose ensemble of cylindrical starting components (English: stack; here also referred to as “ensemble” or “primary preliminary product”) or it is a joined, solid hollow cylinder that comprises the hollow core and at least the jacket traversed by hollow channels (English: cane; here also referred to as “core preliminary product” or “secondary preliminary product”). In the ensemble, the cylindrical starting components and the jacket tube can be partially fused together, in particular at the jacket tube ends. In the core preform, which can be obtained by collapsing and/or thermally drawing the ensemble, the starting components are usually connected to the jacket tube over their entire length.

Further processing of the preform preliminary product results in either the preform or another preform preliminary product, and can involve a single or repeated execution of one or more of the following hot forming processes:
(i) thermal drawing,
(ii) collapse,
(iii) collapse and simultaneous thermal drawing,
(iv) collapse of additional jacket material,
(v) collapse of additional jacket material and subsequent thermal drawing,
(vi) collapse of additional jacket material and simultaneous thermal drawing.

### Antiresonant Element Preform Part

Antiresonant element preforms are cylindrical starting components of a preform preliminary product in the form of a component ensemble, which are arranged for example in a jacket tube inner bore. They are substantially transformed by thermal drawing to form hollow channels in another preliminary product or to form the preform, and they ultimately form the antiresonant elements in the hollow core fiber. Nested antiresonant element preform parts form nested antiresonant elements in the hollow-core fiber. They are composed of a primary tube and at least one additional structural element that is arranged in the inner bore of the primary tube. The at least one further structural element can be an additional tube that abuts the inner jacket surface of the primary tube. The further tune is referred to here as the “secondary tube.”

In the inner bore of the secondary tube, at least one further structural element can be arranged in the case of multiple nested antiresonant element preforms, for example a third tube abutting the inner lateral surface of the nested secondary tube.

A prefabricated ARE preform is a self-supporting structure that contains a primary tube and at least one secondary tube that is connected to the inner side of the primary tube so that the primary tube and secondary tube can be handled together in the form of the structure.

### Thermal Drawing/Collapsing/Elongation Ratio

The preliminary product is thermally drawn (elongated) to form the preform. The drawing can take place without simultaneous collapse. The fiber drawing process is also based on a thermal drawing process. The fiber drawing process is referred to as “ratio drawing” when the cross-sectional structure of the fiber is already established in the preform. The fiber drawing process for hollow core fibers is often not a ratio drawing.

In the collapse process, an inner bore is narrowed or annular gaps between the tubular component are closed or narrowed. The collapse can be combined with thermal drawing.

### Extraction Ratio

Ratio of the component outer diameters before and after thermal drawing.

### Connection End of the Preform

Connection point for applying pressure to the hollow channels of the cross-sectional structure of the preform.

### Cross-Section/Inner Bore

The term “cross-section,” in connection with elongated components such as ARE preforms, preform, or hollow core fiber, always denotes the cross-section perpendicular to the corresponding longitudinal axis and, unless stated otherwise, in the case of tubular components, denotes the cross-section of the outer contour (not the cross-section of the inner contour).

The designation “tube inner face” is also used as a synonym for “tube inner lateral surface,” and the designation “tube outer face” is also used as a synonym for “tube outer lateral surface.” The term “inner bore” in conjunction with a tube does not indicate that the inner bore has been produced by a drilling process.

### EXEMPLARY EMBODIMENT

The invention is explained in more detail below with reference to an exemplary embodiment and a drawing. In detail, in a schematic representation,

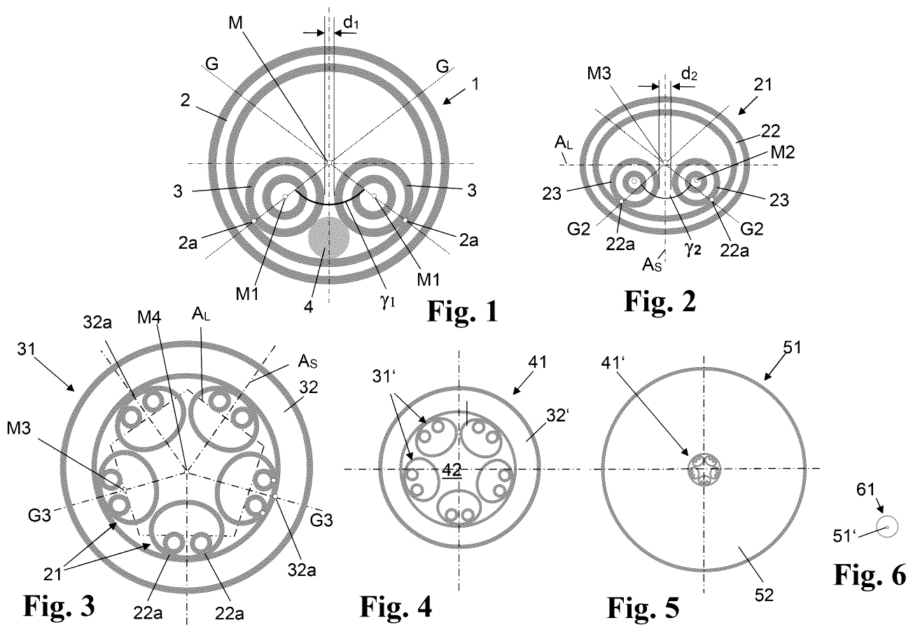

FIG. 1 is a loose component ensemble consisting of a primary tube, two secondary tubes and a spacer in a view of the tube end faces;

FIG. 2 is a cross-section of a prefabricated ARE preform obtained from the component ensemble of FIG. 1 by thermal drawing;

FIG. 3 is a cross-section of a primary preform with a jacket tube and five prefabricated ARE preforms arranged on the inside of the jacket tube;

FIG. 4 is a cross-section of a first secondary preform produced by further processing the primary preform of FIG. 3;

FIG. 5 is a cross-section of a second secondary preform produced by further processing the first secondary preform of FIG. 4; and,

FIG. 6 is a cross-section of a hollow core fiber with an ALIF design produced by further processing the second secondary preform of FIG. 5.

### PRODUCTION OF A PRELIMINARY PRODUCT

FIG. 1 shows, in cross-section, a loose assembly 1 consisting of a primary tube 2, two secondary tubes 3 arranged in the primary tube inner bore 2a, and rod-shaped, short spacers 4 on which the ends of the secondary tubes 3 rest. The tubes (2, 3) are made of undoped quartz glass and have a circular inner and outer cross-section. The central axes M of the primary tube 1 and the two central axes M2 of the secondary tubes 3 run parallel to each other. In cross-section, the two secondary tubes 3 each lie at an azimuthal contact point 2a on the inner side of the primary tube. The azimuthal contact points 2a each lie on straight lines G, which pass through the primary tube center point M and each of the secondary tube center points M1. The straight lines G form an angle g1 with each other. The two elongated secondary tubes 3 have a free distance d1 from each other.

In order to exclude any risk of contact between the secondary tubes 3 during the thermal drawing process, the free distance d1 is preferably at least 1 mm.

The ends of the two secondary tubes 3 are locally thermally bonded to the inside of the primary tube 2 and are also welded to the spacers 4. Thereafter, the fixed assembly 1 is thermally drawn, wherein a predetermined elongation ratio is set.

The result of the drawing process is a prefabricated ARE preform 21 with an oval cross-section, as shown in FIG. 2 using an example. The former primary tube 2 now forms an oval elongated primary tube 22. The two former secondary tubes 3 form elongated secondary tubes 23, which are fused over their entire length with the inside of the elongated primary tube 22. In the cross-section shown, the fusions can be seen as azimuthal contact points 22a.

The elongated secondary tubes 23 also have a substantially circular cross-section with the center point M2. However, the elongated primary tube 22 shows a pronounced ovality, which is characterized by a long main axis A_{L} and a short main axis A_{S} which intersect in the center point M3. The two elongated secondary tubes 23 are located at the same distance on either side of the short main axis A_{S} and they have a free distance d2 from each other. The straight lines G2, which pass through the center point M3 and through the azimuthal contact points 22a of the secondary tubes 23, form an angle g2 with each other. The distance d2 and the angle g2 depend on the degree of ovality of the elongated primary tube 22. The larger this ovality is, the greater the extension of the distance d2 compared to the distance d1 and the wider the angle g2 compared to the angle g1. The angle g2 and angle g1 are mirror-symmetrical to the short main axis in the embodiment. This means that the two half-angles on either side of the axis are equal in size. However, this is not an obligatory symmetry condition.

During the thermal drawing of the fixed assembly 1, the peripheral wall thickness distribution changes due to the fusion of the elongated secondary tubes 3 with the inside of the primary tube 2, which leads to asymmetric heat input and thus to asymmetric flow of the glass and ultimately to the ovality of the elongated primary tube 22.

The prefabricated oval ARE preforms 21 are used to produce an ensemble 31 (primary preform). Five prefabricated ARE preforms 21 are arranged in the inner bore of a jacket tube 32 with an outer diameter of 41 mm. As shown in the cross-sectional view of FIG. 3, the prefabricated ARE preforms 21 are evenly distributed at peripheral contact points 32a on the inside of the jacket tube 32 and are oriented in such a way that the short main axes A_{S} each run radially to the jacket tube center axis M4. A positioning template can be used for this purpose. The two azimuthal contact points 22a on the inside of each of the elongated primary tubes 22 are located on both sides and at the same distance from a straight line G3 which runs through the jacket tube central axis M4 and through the peripheral contact point 32a on the inside of the jacket tube 32. The straight line G3 runs simultaneously in the short main axis A_{S} of the elongated and oval-shaped primary tube 22.

In the region of their front ends, the ARE preforms 21 are fused on the inside of the jacket tube and elongated in a first thermal drawing process to form a preliminary product in the form of a core preform 41 (cane) with an outer diameter of 23 mm.

FIG. 4 shows a cross-section of the core preform 41 (cane) obtained by thermal drawing of the ensemble 31. During this hot forming process, the original prefabricated ARE preforms 21′ are bonded over their entire length to the inside of the former jacket tube 32′. The core preform 41 shows a cross-sectional structure with a hollow core region 42 surrounded by an inner jacket region formed by the former ARE preforms 31′ and an outer jacket region formed by the former jacket tube 32′. Table 1 shows the dimensions of the core preform 41.

TABLE 1

| | |
|---|---|
| Inner diameter [mm] | 14 |
| Wall thickness [mm] | 4.8 |
| Outer diameter [mm] | 23.6 |
| Length [mm] | 1 |
| CSA [m²] | 0.00028 |

### Production of a Preform

FIG. 5 shows a preform 51 which has been obtained by thermally drawing the core preform 41 with simultaneous overlaying with jacket material 52 and whose outer diameter is 25 mm.

The former core preform is designated by reference sign 41′. The preform 51 already shows the cross-sectional structure of the final hollow core fiber 61 (FIG. 6), apart from the sizes of the hollow channels.

Table 2 summarizes further data of preform 51 (designated there as “preform OD25”) and two further embodiments of preforms according to the invention.

TABLE 2

| | Preform OD25 | Preform OD35 | Preform OD40 |
|---|---|---|---|
| OD [m] | 0.025 | 0.035 | 0.04 |
| ID [m] | 0.0058 | 0.0081 | 0.0093 |
| L [m] | 3 | 3.5 | 3.44 |
| L/OD | 120 | 100 | 86 |
| CSA [m²] | 0.00046 | 0.00091 | 0.00119 |
| CSA/L [m] | 0.000155 | 0.000260 | 0.000346 |
| V [mm³] | 1,392,977 | 3,185,275 | 4,089,039 |
| A [mm²] | 235,619 | 384,845 | 432,283 |
| V/A [mm] | 5.9 | 8.3 | 9.5 |

With: OD = outer diameter
ID = inner diameter
L = length
V = volume
A = outer surface

### Production of a Hollow Core Fiber

FIG. 6 schematically shows a hollow core fiber 61 with ALIF design with an outer diameter of 0.23 mm, which is produced by drawing the preform 51. The preform, with its longitudinal axis oriented vertically, is fed from above into a heating zone which is temperature-controlled to approximately 2000° C. The preform has a length of 3 m. It is softened zone by zone, starting with the lower end.

At the upper end of the preform, a connection point for applying pressure is installed, via which gas is supplied to the hollow core region and the hollow channels of the cross-sectional structure, so that an internal overpressure is established in the hollow channels of the inner jacket region and in the hollow core 42 (FIG. 4). The pressure application is differential in the sense that different pressures are exerted on the hollow core 42 and on the hollow channels.

The feed rate to the heating zone is set to 3.2 mm/min, resulting in a material throughput of 3.3 g/min. The average dwell time of the preform in the heating zone is approximately 31 minutes. The total extraction ratio from the preform to the hollow core fiber is 109.

The fiber drawing process is terminated as soon as a temperature of 50° C. has been reached at the connection end of the preform 51 or when the remaining length of the preform that has not yet been thermally drawn is only 0.5 m, whichever of these two events occurs earlier.

1. A preform for an anti-resonant hollow core fiber which comprises a hollow core extending along a fiber longitudinal axis and a jacket surrounding the hollow core and traversed by hollow channels, characterized in that the preform has an outer diameter OD and a length L, wherein OD is at least 25 mm, and the ratio L/OD is greater than 71.5.

2. The preform according to claim 1, wherein the ratio L/OD is in the range between 80 and 200 and preferably in the range between 90 and 150.

3. The preform according to claim 1, wherein the outer diameter OD is in the range of 25 to 50 mm, and is preferably not greater than 45 mm, and is particularly preferably smaller than 30 mm.

4. The preform according to claim 1, wherein the preform length L is at least 3000 mm and preferably at least 4000 mm.

5. The preform according to claim 1, wherein the preform has a volume V (in mm³) and an outer surface area A (in mm²) and in that the ratio V/A is less than 12 (in mm).

6. The preform according to claim 1, wherein the preform has a mass of at least 3 kg.

7. A method for producing a preform for an anti-resonant hollow core fiber according to claim 1, comprising thermally drawing a cylindrical preliminary product having a length of less than 3000 mm.

8. The method according to claim 7, wherein the cylindrical preliminary product has a length of less than 2500 mm, preferably less than 2000 mm.

9. The method according to claim 7, wherein the cylindrical preliminary product has an outer diameter in the range of 40 mm to 200 mm, preferably an outer diameter of at least 60 mm, preferably at least 70 mm.

10. A method for producing a hollow core fiber by thermally drawing a preform that comprises a hollow core region and a jacket region which is traversed by hollow channels that extend between a first preform end and a second preform end, wherein the preform, starting with the first end, is fed to a heating device at a feed rate, is softened therein in part, and the hollow core fiber is continuously drawn off from the softened part while a remaining preform length is shortened, wherein the core region and/or the hollow channels are subjected to pressure, wherein at least one means for applying pressure is arranged at the second preform end, and in that the thermal drawing is terminated as soon as the means for applying pressure and/or the second preform end has reached a predetermined limit temperature and/or the remaining preform length has fallen below a predetermined minimum length.

11. The method according to claim 10, wherein the predetermined limit temperature is lower than 250° C., preferably lower than 200° C.

12. The method according to claim 10, wherein the remaining preform length is at least 300 mm, preferably at least 400 mm.

13. The method according to claim 10, wherein the feed rate is set so as to result in a throughput of at least 0.8 g/min, preferably a throughput in the range of 0.8 g/min to 150 g/min, and particularly preferably a throughput in the range of 3.3 g/min to 85 g/min.

14. The method according to claim 10, wherein the feed rate is set so that the average dwell time of the preform in the heating zone is less than 25 min, preferably in the range of 1.5 to 25 min.

15. The method according to claim 10, wherein the total extraction ratio is set in the range of 100 to 200, preferably to a value in the range of 120 to 180.
